(19) United States
(12) Patent Application Publication
(10) Pub. No.: US 2026/0099384 A1
(43) Pub. Date: Apr. 9, 2026

(54) DYNAMIC ALLOCATION OF CLOUD RESOURCES IN VIRTUAL ENVIRONMENTS

(71) Applicant: International Business Machines Corporation, Armonk, NY (US)

(72) Inventors: Jacob Ryan Jepperson, St. Paul, MN (US); Jennifer M. Hatfield, Portland, OR (US); Sarbajit Kumar Rakshit, Kolkata (IN); Carolina Garcia Delgado, Zapopan (MX)

(21) Appl. No.: 18/905,168

(22) Filed: Oct. 3, 2024

(51) Int. Cl. G06F 9/50

(52) U.S. Cl. CPC G06F 9/5083

(57) ABSTRACT

Dynamic resource allocation in virtual environments includes receiving workflow data associated with a workflow executable in a virtual environment. The workflow is segmented into a plurality of tasks based on the workflow data using a trained ML model. Based on the workflow data, execution data associated with execution of each task of the plurality of tasks, and resource data are determined. The execution data indicates resources for execution of each task of the plurality of tasks, and the resource data is associated with each of the resources. Based on the execution data and the resource data, an allocation of at least one of the one or more resources is controlled. Based on the allocation, each of the plurality of tasks is executed in the virtual environment.

### BACKGROUND

The disclosure relates to dynamic allocation of cloud resources and more particularly, to dynamic allocation of cloud resources in virtual environments.

Executing intelligent workflows, such as product design reviews, in a metaverse environment presents significant challenges due to the complexity of virtual environments. These workflows involve sequences of tasks that require precise execution and coordination, often relying on various collaborative methods and tools. The difficulty lies in managing these tasks effectively while ensuring smooth interaction and integration within the metaverse. The primary issue is understanding the specific requirements of each task, and the type of collaboration needed among participants for executing these tasks. Additionally, identifying and integrating the right cloud services to support these tasks is crucial for maintaining workflow efficiency. As workflows evolve or encounter disruptions, an ability to adapt and manage these changes dynamically is required to prevent inefficiencies or interruptions.

### SUMMARY

According to an embodiment of the disclosure, a computer-implemented method for dynamic allocation of cloud resources in virtual environments is described. The computer-implemented method includes receiving, by a computer, workflow data associated with a workflow executable in a virtual environment. The computer-implemented method further includes segmenting, by the computer using a trained machine learning (ML) model, the workflow into a plurality of tasks based on the workflow data. The ML model is trained based on training workflow data associated with the execution of a plurality of training workflows. The computer-implemented method further includes determining, by the computer using the trained ML model, execution data associated with execution of each task of the plurality of tasks based on the workflow data. The execution data indicates one or more resources for execution of each task of the plurality of tasks. The computer-implemented method further includes determining, by the computer, resource data based on the execution data. The resource data is associated with each of the one or more resources associated with execution of each task of the plurality of tasks. The computer-implemented method further includes controlling, by the computer, an allocation of at least one of the one or more resources based on the execution data and the resource data. The at least one of the one or more resources is allocated for execution of each task of the plurality of tasks in the virtual environment. The computer-implemented method further includes executing, by the computer, each task of the plurality of tasks in the virtual environment based on the allocation.

According to one or more embodiments of the disclosure, a computer system for dynamic allocation of cloud resources in virtual environments is disclosed. The computer system includes a processor set, one or more computer-readable storage media, and program instructions stored on the one or more computer-readable storage media, the program instructions executable by the processor set to cause the processor set to receive workflow data associated with a workflow executable in a virtual environment. The program instructions cause the processor set to segment the workflow into a plurality of tasks based on the workflow data using a trained machine learning (ML) model. The ML model is trained based on training workflow data associated with execution of a plurality of training workflows. The program instructions cause the processor set to determine execution data associated with execution of each task of the plurality of tasks based on the workflow data using the trained ML model. The execution data indicates dependency data associated with each task of the plurality of tasks and one or more resources for execution of each task of the plurality of tasks. The program instructions cause the processor set to determine resource data based on the execution data. The resource data is associated with each of the one or more resources associated with execution of each task of the plurality of tasks. The program instructions cause the processor set to control an allocation of at least one of the one or more resources based on the dependency data and the resource data. The at least one of the one or more resources is allocated for execution of each task of the plurality of tasks in the virtual environment. The program instructions cause the processor set to execute each task of the plurality of tasks in the virtual environment based on the allocation.

According to one or more embodiments of the disclosure, a computer program product for dynamic allocation of cloud resources in virtual environments is provided. The computer program product includes a computer-readable storage medium having program instructions embodied therewith. The program instructions are executable by a system to cause the system to receive workflow data associated with a workflow executable in a virtual environment. The program instructions further cause the system to segment the workflow into a plurality of tasks based on the workflow data using a trained machine learning (ML) model. The ML model is trained based on training workflow data associated with execution of a plurality of training workflows. The program instructions further cause the system to determine execution data associated with execution of each task of the plurality of tasks based on the workflow data using the trained ML model. The execution data indicates one or more resources for execution of each task of the plurality of tasks. The program instructions further cause the system to determine resource data based on the execution data. The resource data is associated with each of the one or more resources associated with execution of each task of the plurality of tasks. The program instructions further cause the system to control an allocation of at least one of the one or more resources based on the execution data and the resource data. The at least one of the one or more resources is allocated for execution of each task of the plurality of tasks in the virtual environment. The program instructions further cause the system to execute each task of the plurality of tasks in the virtual environment based on the allocation.

### BRIEF DESCRIPTION OF THE DRAWINGS

The following description will provide details of preferred embodiments with reference to the following figures wherein:

FIG. 1 is a diagram that illustrates a computing environment for dynamic allocation of cloud resources in a virtual environment, in accordance with an embodiment of the present disclosure;

FIG. 2 is a diagram that illustrates a network environment for dynamic allocation of the cloud resources in the virtual environment, in accordance with an embodiment of the present disclosure;

FIG. 3 is a block diagram that illustrates segmentation of a workflow using a Machine Learning (ML) model, in accordance with an embodiment of the present disclosure;

FIG. 4A is a flowchart that illustrates a method for determining dependency data associated with a plurality of tasks, in accordance with an embodiment of the present disclosure;

FIG. 4B is a flowchart that illustrates a method for generating order data for execution of the plurality of tasks, in accordance with an embodiment of the present disclosure;

FIG. 5A is a flowchart that illustrates a method for performing an operation for execution of first task or second task, in accordance with an embodiment of the present disclosure;

FIG. 5B is a flow diagram that illustrates an exemplary scenario of performing a first operation, in accordance with an embodiment of the present disclosure;

FIG. 6 is a flowchart that illustrates a method for allocating one or more resources to one or more user devices for executing tasks, in accordance with an embodiment of the present disclosure;

FIG. 7 is a block diagram that illustrates execution of each task of the plurality of tasks based on allocation of resources to one or more user devices, in accordance with an embodiment of the present disclosure;

FIG. 8 is a flowchart that illustrates a method for automating one or more tasks of the plurality of tasks, in accordance with an embodiment of the present disclosure; and

FIG. 9 is a flowchart that illustrates an exemplary method for dynamically allocating one or more resources for workflow execution in a virtual environment, in accordance with an embodiment of the present disclosure.

### DETAILED DESCRIPTION

Conventional approaches for executing workflows, particularly in complex and collaborative environments like the metaverse, often face significant limitations. Traditional methods typically rely on static, predefined processes that do not adapt well to the dynamic and evolving nature of modern tasks. This rigidity may lead to inefficiencies as workflows are not optimized for real-time changes in data, security requirements, or participant roles. Furthermore, conventional systems often struggle with integrating multiple cloud services seamlessly, which can result in fragmented data management and security vulnerabilities. These approaches also tend to lack the flexibility needed to scale with increasing user participation and data volume, leading to potential bottlenecks and reduced overall performance. As a result, conventional methods may delay the ability to unlock new value and optimize workflows effectively in a rapidly changing digital landscape.

Intelligent workflows transform how tasks are executed by integrating automation, AI, and analytics to optimize efficiency and unlock new value. In the context of the metaverse, the disclosed system introduces an innovative method for executing these workflows by dynamically integrating cloud services for each segmented task. The process begins with breaking down the workflow into discrete operations, analyzing data required for each step, and determining security needs for each segmented step. The system then configures the metaverse environment to support these requirements, ensuring that each part of the workflow operates smoothly and efficiently within its virtual context. This approach facilitates a tailored environment that enhances the overall execution of complex workflows in a collaborative metaverse setting.

Additional key feature of the proposed system is its ability to manage data communication and security throughout the workflow. As tasks are executed, the system identifies information that needs to be transferred between operations and establishes data communication services with required security measures. This ensures seamless and secure data transfer, which is crucial for maintaining workflow integrity and efficiency. Additionally, the system validates a completion state of each step to confirm that tasks are performed in a correct sequence, thus ensuring that the entire workflow progresses as planned and reaches a successful completion. This capability addresses the challenges of managing collaborative content and validating progress in a dynamic virtual environment.

The disclosed system also addresses scalability and user management challenges inherent in metaverse workflows. With the increasing number of participants and the corresponding rise in data volume, the disclosed system dynamically allocates suitable cloud resources to handle the evolving demands. The system maintains a roster of users who are optimized for various tasks based on an opt-in model, allowing for efficient and effective use of resources. This flexibility ensures that the system can adapt to changing levels of participation and data needs, making it well-suited for diverse and expanding collaborative environments in the metaverse. By combining these features, the proposed system enhances the execution of intelligent workflows and sets a new standard for integrating cloud services and user management in virtual collaborative spaces.

According to an embodiment of the disclosure, a computer-implemented method for dynamic allocation of cloud resources in virtual environments is described. The computer-implemented method includes receiving, by a computer, workflow data associated with a workflow executable in a virtual environment. The computer implemented method further includes segmenting, by the computer using a trained machine learning (ML) model, the workflow into a plurality of tasks based on the workflow data, the ML model is trained based on training workflow data associated with execution of a plurality of training workflows. The computer implemented method further includes determining, by the computer using the trained ML model, execution data associated with execution of each task of the plurality of tasks. The execution data indicates one or more resources for execution of each task of the plurality of tasks based on the workflow data. The computer implemented method further includes determining, by the computer, resource data based on the execution data. The resource data is associated with each of the one or more resources associated with execution of each task of the plurality of tasks. The computer implemented method further includes controlling, by the computer, an allocation of at least one of the one or more resources based on the execution data and the resource data. The at least one of the one or more resources is allocated for execution of each task of the plurality of tasks in the virtual environment. The computer implemented method further includes executing, by the computer, each task of the plurality of tasks in the virtual environment based on the allocation.

In various embodiments of the disclosure, the execution data includes at least one of dependency data for each task of the plurality of tasks, complexity data for execution of each task of the plurality of tasks, technical requirement data for execution of each task of the plurality of tasks, or security requirement data for execution of each task of the plurality of tasks.

In various embodiments of the disclosure, the computer implemented method further includes predicting, by the computer using the ML model, input data for execution of each task of the plurality of tasks. The computer implemented method further includes predicting, by the computer using the ML model, output data associated with execution of each task of the plurality of tasks. The computer implemented method further includes determining, by the computer using the ML model, the dependency data associated with each task of the plurality of tasks based on the input data and the output data. The computer implemented method further includes generating, by the computer, order data based on the dependency data. The order data is generated for execution of the plurality of tasks.

In various embodiments of the disclosure, the computer implemented method further includes receiving, by the computer, user information associated with each of a plurality of users of the virtual environment. The user information includes skills data of each user of the plurality of users and user device data of each user of the plurality of users. The computer implemented method further includes allocating, by the computer, the one or more resources to one or more user devices associated with a set of users of the plurality of users based on the user information associated with each user of the set of users. The one or more resources are allocated to the one or more user devices in the virtual environment for execution of a task of the plurality of tasks.

In various embodiments of the disclosure, the computer implemented method further includes determining, by the computer, service data associated with a plurality of service resources executable in the virtual environment. The plurality of service resources includes the one or more resources associated with execution of each task of the plurality of tasks. The computer implemented method further includes segmenting, by the computer using the trained ML model, the workflow into the plurality of tasks based on the service data.

In various embodiments of the disclosure, the plurality of tasks includes a first task and a second task, such that the dependency data indicates a dependency relationship between the first task and the second task. The computer implemented method further includes determining, by the computer, first execution data associated with the first task. The first execution data indicates one or more first resources of the one or more resources for execution of the first task. The execution data includes the first execution data. The computer implemented method further includes determining, by the computer, second execution data associated with the second task. The second execution data indicates one or more second resources of the one or more resources for execution of the second task. The execution data includes the second execution data. The computer implemented method further includes determining, by the computer, resource data associated with each of the one or more first resources and the one or more second resources. The computer implemented method further includes controlling, by the computer, an allocation of at least one of the one or more first resources or the one or more second resources for execution of the first task and the one or more second resources based on the dependency relationship. The one or more first resources are allocated for execution of the second task.

In various embodiments of the disclosure, the dependency relationship indicates a dependency of the first task on the second task. The computer implemented method further includes controlling, by the computer, the allocation of the one or more first resources for execution of the first task in the virtual environment. The computer implemented method further includes receiving, by the computer from at least one of the one or more first resources, a completion status of the first task. The computer implemented method further includes validating, by the computer, the completion status of the first task. The computer implemented method further includes controlling, by the computer, the allocation of the one or more second resources based on the validation. The one or more second resources are allocated for execution of the second task in the virtual environment.

In various embodiments of the disclosure, each of the one or more first resources for execution of the first task and the one or more second resources for execution of the second task includes a third resource. The computer implemented method further includes determining, by the computer, resource data associated with the third resource. The resource data indicates one or more attributes of the third resource. The computer implemented method further includes executing, by the computer, at least one of the first task or the second task using the third resource based on the one or more attributes.

In various embodiments of the disclosure, the computer implemented method further includes determining, by the computer, unavailability of the third resource based on the one or more attributes. The unavailability of the third resource corresponds to a failure in execution of at least one of the first task or the second task. The computer implemented method further includes performing, by the computer, at least one of scaling the third resource or triggering a notification for the third resource based on the determination of the unavailability of the third resource.

In various embodiments of the disclosure, the computer implemented method further includes determining, by the computer, the unavailability of the third resource based on the one or more attributes for execution of at least one of the first task or the second task. The computer implemented method further includes initiating, by the computer, an updated instance of the third resource based on the determination. The updated instance is initiated for execution of at least one of the first task or the second task. The computer implemented method further includes allocating, by the computer, the updated instance of the third resource for execution of at least one of the first task or the second task.

In various embodiments of the disclosure, the computer implemented method further includes analyzing, by the computer using the ML model, each task of the plurality of tasks based on the workflow data. The computer implemented method further includes determining, by the computer using the ML model, one or more tasks of the plurality of tasks based on the analysis. The one or more tasks are to be automated. The computer implemented method further includes automating, by the computer, the one or more tasks of the plurality of tasks based on the corresponding execution data.

In various embodiments of the disclosure, the one or more resources associated with execution of each task of the plurality of tasks are cloud resources.

In various embodiments of the disclosure, the virtual environment corresponds to a metaverse environment.

In various embodiments of the disclosure, the one or more resources includes at least a digital twin, an Artificial Intelligence (AI) model, one or more security resources, one or more analytics resources, and one or more load balancing resources.

According to one or more embodiments of the disclosure, a computer system for dynamic allocation of cloud resources in virtual environments is disclosed. The computer system includes a processor set, one or more computer-readable storage media, and program instructions stored on the one or more computer-readable storage media, the program instructions executable by the processor set to cause the processor set to receive workflow data associated with a workflow executable in a virtual environment. The program instructions cause the processor set to segment the workflow into a plurality of tasks based on the workflow data using a trained machine learning (ML) model. The ML model is trained based on training workflow data associated with execution of a plurality of training workflows. The program instructions cause the processor set to determine execution data associated with execution of each task of the plurality of tasks based on the workflow data using the trained ML model. The execution data indicates dependency data associated with each task of the plurality of tasks and one or more resources for execution of each task of the plurality of tasks. The program instructions cause the processor set to determine resource data based on the execution data. The resource data is associated with each of the one or more resources associated with execution of each task of the plurality of tasks. The program instructions cause the processor set to control an allocation of at least one of the one or more resources based on the dependency data and the resource data. The at least one of the one or more resources is allocated for execution of each task of the plurality of tasks in the virtual environment. The program instructions cause the processor set to execute each task of the plurality of tasks in the virtual environment based on the allocation. In various embodiments of the disclosure, the execution data includes at least one of complexity data for execution of each task of the plurality of tasks, technical requirement data for execution of each task of the plurality of tasks, or security requirement data for execution of each task of the plurality of tasks.

In various embodiments of the disclosure, the program instructions cause the processor set to predict using the ML model, input data for execution of each task of the plurality of tasks. The program instructions cause the processor set to predict, using the ML model, output data associated with execution of each task of the plurality of tasks. Further, the program instructions cause the processor set to determine using the ML model, the dependency data associated with each task of the plurality of tasks based on the input data and the output data. Further, the program instructions cause the processor set to generate order data based on the dependency data. The order data is generated for execution of the plurality of tasks.

In various embodiments of the disclosure, the program instructions cause the processor set to receive user information associated with each of a plurality of users of the virtual environment. The user information may include skills data of each user of the plurality of users and user device data of each user of the plurality of users. The program instructions cause the processor set to allocate the one or more resources to one or more user devices associated with a set of users of the plurality of users based on the corresponding user information. The one or more resources are allocated to the one or more user devices in the virtual environment for execution of a task of the plurality of tasks.

In various embodiments of the disclosure, the program instructions cause the processor set to determine service data associated with a plurality of service resources executable in the virtual environment. The plurality of service resources includes the one or more resources associated with execution of each task of the plurality of tasks. The program instructions cause the processor set to segment, using the trained ML model, the workflow into the plurality of tasks based on the service data.

According to one or more embodiments of the disclosure, a computer program product for dynamic allocation of cloud resources in virtual environment is provided. The computer program product includes a computer-readable storage medium having program instructions embodied therewith. The program instructions are executable by a system to cause the system to receive workflow data associated with a workflow executable in a virtual environment. The program instructions further cause the system to segment the workflow into a plurality of tasks based on the workflow data using a trained machine learning (ML) model. The ML model is trained based on training workflow data associated with execution of a plurality of training workflows. The program instructions further cause the system to determine execution data associated with execution of each task of the plurality of tasks based on the workflow data using the trained ML model. The execution data indicates one or more resources for execution of each task of the plurality of tasks. The program instructions further cause the system to determine resource data based on the execution data. The resource data is associated with each of the one or more resources associated with execution of each task of the plurality of tasks. The program instructions further cause the system to control an allocation of at least one of the one or more resources based on the execution data and the resource data. The at least one of the one or more resources is allocated for execution of each task of the plurality of tasks in the virtual environment. The program instructions further cause the system to execute each task of the plurality of tasks in the virtual environment based on the allocation.

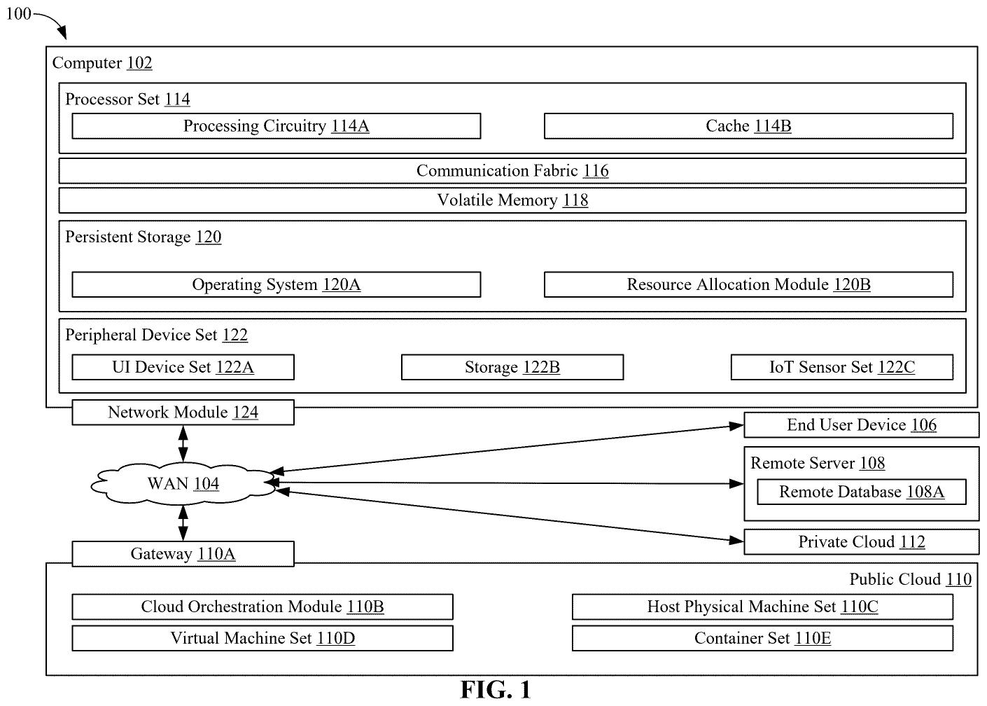

FIG. 1 is a diagram that illustrates a computing environment for dynamic allocation of cloud resources in virtual environment, in accordance with an embodiment of the disclosure. With reference to FIG. 1, there is shown a computing environment 100 that contains an example of an environment for execution of at least some of the computer code involved in performing the methods, such as a resource allocation module 120B. In addition to the resource allocation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the resource allocation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the dynamic modification of the resource allocation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the resource allocation module 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and other sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

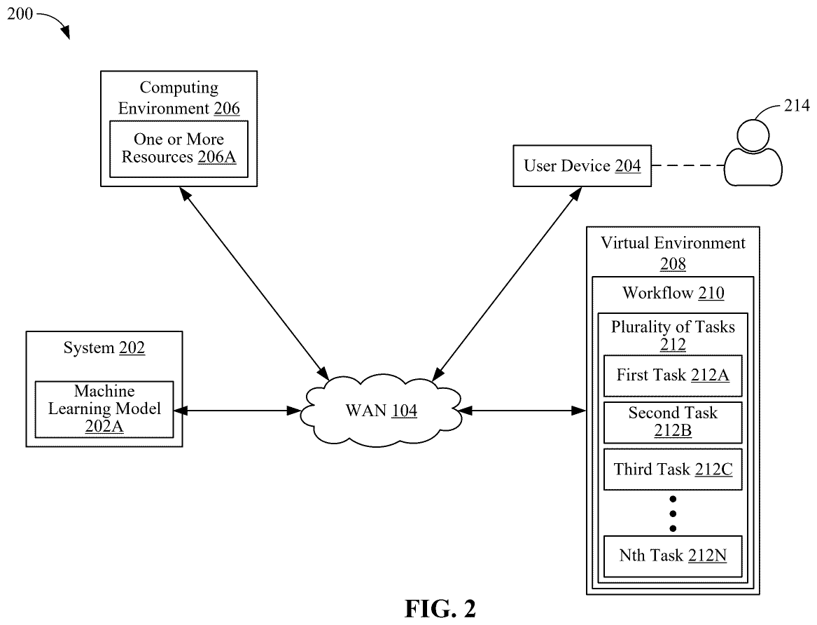

FIG. 2 is a diagram that illustrates an environment for dynamic allocation of cloud resources in virtual environment, in accordance with an embodiment of the disclosure. FIG. 2 is explained in conjunction with elements from FIG. 1. With reference to FIG. 2, there is shown a diagram of a network environment 200. The network environment 200 includes a system 202, a user device 204, a computing environment 206, and a virtual environment 208. There is further shown a workflow 210 being executed in the virtual environment 208. The workflow 210 further includes a plurality of tasks 212. The plurality of tasks 212 includes a first task 212A, a second task 212B, a third task 212C up to an Nth task 212N. The network environment 200 further includes the WAN 104 of FIG. 1.

The system 202 may include suitable logic, circuitry, interfaces, and/or code that may be configured for dynamically configuring cloud services for seamless intelligent workflow execution in the metaverse. The system 202 addresses intelligent workflow execution in the virtual environment such as, but not limited to, Metaverse by focusing on two key aspects. The two key aspects may be, for example, process optimization and self-healing. The process optimization leverages extensive digital footprints and real-time data in the virtual environment 208 to refine workflows, such as the workflow 210 executable in the virtual environment 208. This may enable techniques like skipping certain tasks based on machine learning (ML) insights. The self-healing involves dynamically adjusting one or more resources 206A, for example, cloud resources to prevent downtime and maintain performance. The virtual environment 208 offers richer, real-time workflow data for both process improvement and proactive issue resolution.

Pursuant to the present disclosure, a machine learning (ML) model 202A is utilized in forecasting and optimizing the workflow 210 for execution. The ML model 202A may optimize the workflow 210 by leveraging training workflow data and predictive analytics. The ML model 202A may utilize statistical techniques and linear regression to identify the most efficient way to execute the workflow 210. In an embodiment, the statistical models are used to analyze training workflow data to uncover patterns and relationships between a plurality of tasks in the training workflow data. These models often involve techniques such as time series analysis, hypothesis testing, and probability distributions. For example, a time series analysis might be employed to predict future task durations based on historical execution times. By understanding the variability and trends in training workflow data, statistical models may provide insights into expected performance and potential bottlenecks.

Further, linear regression models are a subset of the statistical methods that are utilized for predicting continuous outcomes based on one or more predictor variables. In workflow 210 optimization, the linear regression model may be used to forecast task durations or resource needs by establishing relationships between variables. For example, the linear regression model may predict the time required for a task based on factors such as task complexity, resource availability, and past performance metrics. By fitting a linear equation to the training workflow data, the model may estimate the expected execution time for similar tasks in execution of the workflow 210 on a current day of operation.

In an embodiment, the virtual environment 208 such as the metaverse is a collective virtual shared space that is created by the convergence of virtually enhanced physical reality and physically persistent virtual reality. It represents an immersive, interactive digital world where users, such as the user 216 may interact with each other and with digital environments in real-time. The metaverse extends beyond isolated virtual reality (VR) environments by integrating a diverse array of digital spaces and experiences into a unified ecosystem. It leverages a range of technologies to achieve seamless interoperation between these environments, employing interoperability standards, real-time data synchronization, and advanced immersive technologies. This interconnected system enables users to transition fluidly between different virtual worlds and augmented reality (AR) overlays, ensuring a coherent and persistent digital experience across multiple platforms and applications.

The user device 204 may include suitable logic, circuitry, interfaces, and/or code that may be configured to receive the workload data from the user 216 associated with the user device 204 and transmit the received input to the system 202. Examples of the user device 204 may include, but are not limited to, a computing device, a server, a computer work-station, a smartphone, an Augmented Reality (AR) device, a Virtual Reality (VR) device, a cellular phone, a mobile phone, a mainframe machine, a gaming device, a consumer electronic (CE) device, a head-mounted device, a projection-based system, and/or any other device with computer vision display capabilities.

The computing environment 206 may include suitable logic, circuitry, and interfaces, and/or code that is configured to host the one or more resources 206A. In an exemplary embodiment, the computing environment 206 is implemented as a cloud server and may execute operations through web applications, cloud applications, Hypertext Transfer Protocol (HTTP) requests, repository operations, file transfer, and the like. Other example implementations of the computing environment 206 include, but are not limited to, a database server, a file server, a web server, a media server, an application server, a mainframe server, or a cloud computing server.

In an embodiment, the computing environment 206 includes the one or more resources 206A. The one or more resources 206A are, for example, but not limited to, a digital twin, an artificial intelligence (AI) model, one or more security resources, one or more analytics resources, and one or more load balancing resources. The system 202 is configured to dynamically control an allocation of the one or more resources 206A for optimal execution of the workflow. For example, the optimal execution of the workflow 210 may result in reduced time, better speed and/or improved output during the execution of the workflow 210.

In an embodiment, the digital twin serves as a highly detailed virtual replica of physical entities, environments, or systems, seamlessly integrated into the expansive digital ecosystem. This virtual model mirrors its real-world counterpart in real-time, utilizing data from sensors and IoT devices to dynamically reflect changes and conditions. Within the metaverse, the digital twins facilitate immersive simulations and interactions, allowing users to explore and engage with their physical counterparts in a virtual space. This enables advanced analytics, predictive maintenance, and scenario testing in a digital context, enhancing decision-making and operational efficiency across a variety of applications, from urban planning and infrastructure management to personalized healthcare and manufacturing. By bridging physical and digital realms, digital twins in the metaverse create a more interconnected, interactive, and responsive virtual environment.

In various embodiments, the artificial intelligence (AI) model deployed through cloud services plays a crucial role in enhancing virtual experiences by providing advanced functionalities and real-time processing. Hosted on cloud platforms, this AI model can handle large-scale data from user interactions, environmental sensors, and virtual devices, enabling it to perform tasks such as personalizing avatars, managing dynamic virtual environments, and offering context-sensitive assistance. The cloud infrastructure supports the model's scalability and flexibility, allowing it to adjust one or more resources 206A based on demand and ensuring seamless performance across the virtual environment 208. Additionally, cloud deployment facilitates continuous updates and improvements to the AI model, ensuring it remains up to date with the latest advancements and can efficiently handle the diverse needs of users within the metaverse.

In operation, the system 202 is configured to receive workflow data associated with the workflow 210 executable in the virtual environment 208. The workflow 210 corresponds to a set of processes that occur in a particular order. The workflow 210 is a mechanism by which a goal may be reached, for example, to generate an output. The virtual environment 208 may correspond to, for example, the metaverse environment. In an exemplary embodiment, the system 202 receives the workflow data associated with the workflow 210. In an exemplary embodiment, the workflow 210 may correspond to a design review for a product.

In an embodiment, once the system 202 receives the workflow, the system 202 is configured to segment the received workflow 210 into the plurality of tasks 212 based on the workflow data using the trained ML model 202A. In an example, the workflow data includes at least an objective associated with the workflow 210 and specific goals that need to be achieved thorough execution of the workflow 210 in the virtual environment 208. In an exemplary embodiment, the system 202 trains the ML model 202A on training workflow data associated with execution of a plurality of training workflows. In an embodiment, the system 202 trains the ML model 202A in a historical time period. In one scenario, the training workflows may include at least the workflow 210. The system 202 may have executed the workflow 210 in the historical time period. Further, the workflow data associated with execution of the workflow 210 in the historical time period may correspond to the training workflow data used for the training of the ML model 202A. In an embodiment, the system 202 segments the workflow 210 by utilizing the trained ML model into the plurality of tasks 212. The plurality of tasks 212 includes, for example, the first task 212A, the second task 212B, the third task 212C, up to the Nth task 212N.

In an exemplary embodiment, if the workflow 210 corresponds to the design review of the product, the system 202 utilizes the trained ML model 202A to segment the workflow 210 into the plurality of tasks 212. The plurality of tasks 212 corresponds to major tasks that need to be executed for an overall execution of the workflow 210. Each task of the plurality of tasks 212 represents an individual activity that contributes to achieving a specific goal included in the workflow data. In an embodiment, the plurality of tasks 212 associated with the workflow 210 corresponding to the design review of the product may include the first task 212A corresponding to the visual design review of the product, the second task 212B corresponding to the digital twin simulation of the product, the third task 212C corresponding to the safety evaluation of the product, a fourth task corresponding to functional testing of the product, and a fifth task corresponding to user acceptance testing of the product. To this end, the product may correspond to, for example, but not limited to, a smartphone, a computer application, an industrial product, an automotive vehicle, etc. In an exemplary embodiment, each task of the plurality of tasks 212 may be segmented into subtasks based on the complexity of each of the plurality of tasks 212.

In an embodiment, the system 202 is configured to determine execution data associated with execution of each task of the plurality of tasks 212 based on the workflow data using the ML model 202A. In an embodiment, the execution data includes dependency data associated with each task of the plurality of tasks 212, complexity data for execution of each task of the plurality of tasks 212, technical requirement data for execution of each task of the plurality of tasks 212, or security requirement data for execution of each task of the plurality of tasks 212. The execution data is indicative of one or more resources 206A required for execution of each task of the plurality of tasks 212. In an exemplary embodiment, based on the segmentation of the workflow 210 into the plurality of tasks 212 (such as the first task 212A, the second task 212B, the third task 212C, . . . , and the Nth task 212N), the system 202 determines the one or more resources 206A required for execution of the first task 212A corresponding to the visual design review of the product, the second task 212B corresponding to the digital twin simulation of the product, the third task 212C corresponding to the safety evaluation of the product, the fourth task corresponding to the functional testing of the product and the fifth task corresponding to the user acceptance testing of the product. In an embodiment, the one or more resources 206A correspond to cloud resources. The cloud resources include, but are not limited to, cloud storage, compute instances, managed databases, contained orchestration, serverless computing, a digital twin, an Artificial Intelligence (AI) model, one or more security resources, one or more analytics resources, and one or more load balancing resources.

In an embodiment, the system 202 is configured to determine resource data based on the determined execution data. The resource data is associated with each of the one or more resources 206A associated with execution of each task of the plurality of tasks 212. In an embodiment, the resource data for a resource associated with a task may be indicative of one or more attributes associated with the resource that may be utilized for executing the task of the plurality of tasks 212. For example, if a resource required for execution of the first task 212A corresponds to a cloud storage, then the resource data may indicate type, compatibility, and data storage amount available at the cloud storage. In an exemplary embodiment, the attribute associated with the type of storage required for execution of the first task 212A may include, for example, but not limited to, object storage, file storage, block storage, and archive storage.

In an embodiment, the system 202 is configured to control the allocation of at least one of the one or more resources 206A based on the execution data and the resource data. The system 202 allocates at least one of the one or more resources for execution of each task of the plurality of tasks 212 in the virtual environment 208. In an exemplary embodiment, once the system 202 determines one or more resources required for execution of the first task 212A of the plurality of tasks 212, the system 202 allocates the determined one or more resources 206A to, for example, a computing entity for execution of the first task 212A using the first task 212A.

In an embodiment, the system 202 is further configured to execute each task of the plurality of tasks 212 in the virtual environment 208 based on the allocation of resource(s) for each of the plurality of tasks 212. For example, the resource(s) allocated to a task may be used for executing the task. To this end, the allocation of the resource(s) for executing the task and further execution of the task may be controlled based on the dependency data. In an example, when the dependency data indicates that the first task 212A is dependent on the second task 212B, then the resource(s) may first be allocated for execution of the second task 212B. Once the second task 212B has been executed, the resource(s) or different resources may be allocated for execution of the first task 212A.

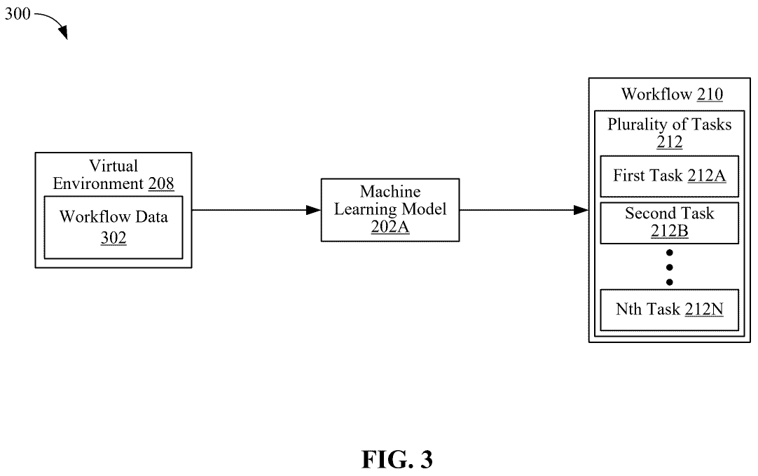

FIG. 3 illustrates a block diagram 300 for segmentation of the workflow 210 using the ML model 202A, in accordance with an embodiment of the disclosure. FIG. 3 is explained in conjunction with elements from FIG. 1 and FIG. 2.

In an embodiment, the ML model 202A receives and processes the workflow data 302 associated with the workflow 210. In an embodiment, the workflow data 302 is associated with the workflow 210 that is to be executed in the virtual environment 208. For example, the workflow 210 may correspond to review of a product. Such review may be executed in the virtual environment 208 such as, the metaverse. Further, data associated with the workflow 210 corresponds to the workflow data 302. In an exemplary embodiment, the workflow data 302 associated with the design review of the product may include, but not limited to, details about the product that is to be reviewed in the virtual environment 208, details about the plurality of users associated with the review of the product, and the one or more resources 206A required for execution of the workflow 210 in the virtual environment 208. The ML model 202A analyses the workflow data 302 to understand underlying processes and requirements to execute the workflow 210. Further, the ML model 202A segments the workflow 210 into the plurality of tasks 212. Each task of the plurality of tasks 212 represents a specific function or operation needed for the completion of the workflow 210.

In an embodiment, the ML model 202A is trained using training workflows executed in a virtual environment 208 like the metaverse in the historical time period. Each workflow represents an operation, encompassing multiple stages and interactions. By analyzing the training workflows, the ML model 202A learns to identify patterns and dependencies within the workflows. This training process involves inputting the ML model 202A with various scenarios and task structures, allowing the ML model 202A to understand how different subtasks contribute to the overall execution of the workflow. Once trained, the ML model 202A is capable of segmenting a given workflow into manageable subtasks, optimizing efficiency and streamlining execution in the virtual environment 208.

The segmentation of the workflow 210 allows for efficient distribution and execution within the virtual environment 208, such as the metaverse environment. By breaking down the workflow 210 into the plurality of tasks 212, the system 202 may allocate at least one of the one or more resources 206A to each task of the plurality of tasks 212, prioritize actions, and streamline interactions between various virtual entities effectively. This task segmentation enhances overall efficiency and enables dynamic adjustments as new data or changes in the virtual environment 208 occur, ensuring that workflows remain adaptable and responsive to evolving conditions.

In an exemplary embodiment, based on the segmentation of the workflow 210 into the tasks 212 and dependencies between the tasks 212, the system 202 is configured to create a visual representation of the workflow 210, for example, using a flowchart. For each major task (for example, the first task 212A, the second task 212B, the third task 212C, etc.), the system 202 is configured to segment it down further into smaller, more manageable sub-tasks. This helps in assigning the one or more resources 206A required for execution of the tasks 212 and tracking progress more effectively. In this scenario, training workflow data 302 may be utilized for training the ML model 202A to effectively segment workflows.

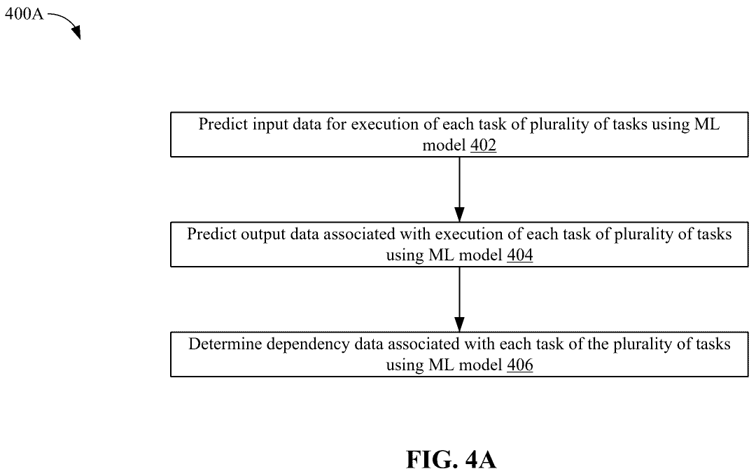

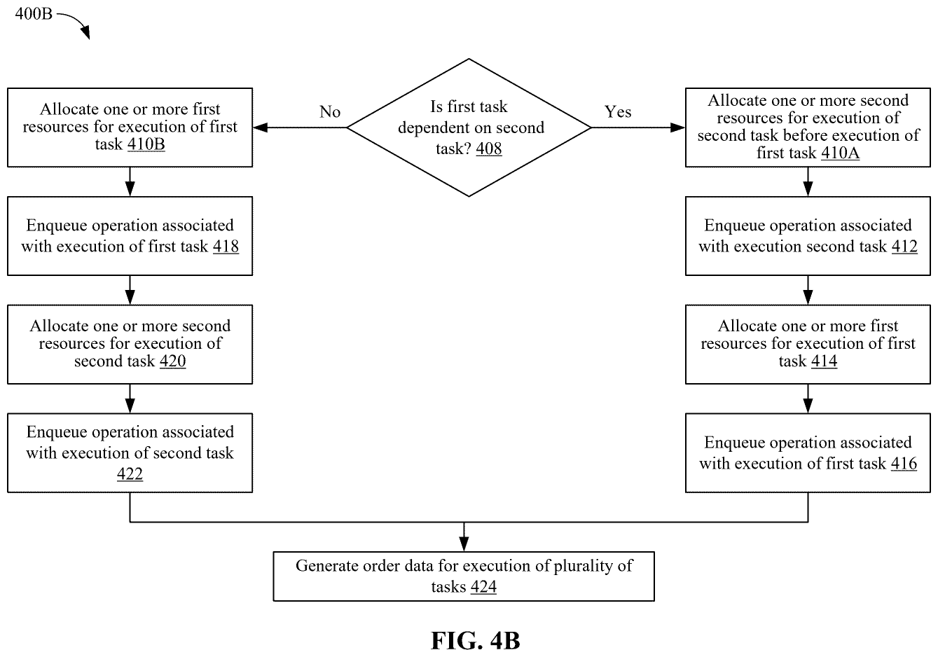

FIG. 4A is a flowchart 400A of a method for determining dependency data associated with the plurality of tasks 212, in accordance with an embodiment of the disclosure. FIG. 4A is explained in conjunction with elements from FIG. 1, FIG. 2, and FIG. 3.

At 402, input data for execution of each task of the plurality of tasks 212 is predicted. In an example, the system 202 is configured to predict the input data for execution of each task of the plurality of tasks 212, using the ML model 202A. The ML model 202A is trained on the training workflow data 302 associated with execution of a plurality of the training workflows. In an embodiment, upon the segmentation of the workflow 210 into the plurality of tasks 212, the system 202 predicts the input data required for execution of the first task 212A, the second task 212B, the third task 212C, up to the Nth task 212N.

In an exemplary embodiment, the system 202 segments the workflow 210 corresponding to the design review for the product into the plurality of tasks 212. The plurality of tasks 212 is, for example, the visual design review of the product, the digital twin simulation of the product, the safety evaluation of the product, the functional testing of the product, and the user acceptance testing of the product. Further, the system 202 predicts input data required for executing the visual design review of the product in the virtual environment 208, input data required for executing the digital twin simulation of the product in the virtual environment 208, input data required for executing the safety evaluation of the product in the virtual environment 208, input data required for executing the functional testing of the product in the virtual environment 208, and input data required for executing the user acceptance testing of the product in the virtual environment 208.

Further, for predicting the input data associated with each task of the plurality of tasks 212, the system 202 utilizes the trained ML model 202A. In an exemplary embodiment, the ML model 202A is trained on the training workflows. These training workflows may include workflows that resemble characteristics of the workflow 210 corresponding to the design review for the product. Based on the learning from execution of the training workflows, the ML model 202A predicts the input data required for each task of the plurality of tasks 212.

At 404, output data for execution of each task of the plurality of tasks 212 is predicted. In an example, the system 202 is configured to predict the output data for execution of each task of the plurality of tasks 212 using the trained ML model 202A. In an embodiment, the system 202 predicts the output data associated with execution of the first task 212A, the second task 212B, the third task 212C, up to the Nth task 212N.

In an exemplary embodiment, the system 202 segments the workflow 210 corresponding to the design review for the product into the plurality of tasks 212. The plurality of tasks 212 is the visual design review of the product, the digital twin simulation of the product, the safety evaluation of the product, the functional testing of the product, and the user acceptance testing of the product. Further, the system 202 predicts output data generated on executing the visual design review of the product in the virtual environment 208, output data that is to be generated on executing the digital twin simulation of the product in the virtual environment 208, output data that is to be generated on executing the safety evaluation of the product in the virtual environment 208, output data that is to be generated on executing the functional testing of the product in the virtual environment 208, and output data that is to be generated on executing the user acceptance testing of the product in the virtual environment 208.

For predicting the output data associated with execution of each task of the plurality of tasks 212, the system 202 utilizes the trained ML model 202A. In an exemplary embodiment, the ML model 202A is trained on training workflows including the workflows that resemble the characteristics of the workflow 210 corresponding to the design review for the product. Based on the learnings from execution of the training workflows, the ML model 202A predicts the output data that is to be generated on execution of each task of the plurality of tasks 212.

At 406, dependency data associated with each task of the plurality of tasks 212 is determined. In an example, the system 202 is configured to determine the dependency data associated with each task of the plurality of tasks 212, using the ML model 202A. In an embodiment, the system 202 analyses the predicted input data for execution of a task of the plurality of tasks 212 and the predicted output data associated with execution of the task to determine the dependency data associated with the task on any other tasks(s) from the plurality of tasks 212. In an embodiment, the dependency data is indicative of execution of one task of the plurality of tasks 212 being dependent on execution of one or more tasks of the plurality of tasks 212.

In an exemplary embodiment, the system 202 analyses the predicted input data for execution of the plurality of tasks 212 associated with the workflow 210 corresponding to the design review for the product. Upon analysis, the system 202 utilizes the ML model 202A to determine which task of the plurality of tasks 212 is dependent on the one or more other tasks of the plurality of tasks 212 associated with the workflow 210. For example, the system 202 determines that execution of the second task 212B, which corresponds to digital twin simulation of the product depends on execution of the first task 212A which corresponds to the visual design review of the product. Similarly, the system 202 determines dependency data associated with each task of the plurality of tasks 212 associated with the workflow 210. The system 202 identifies what tasks must be executed and are dependent on the completion of one or more tasks.

FIG. 4B is a flowchart 400B of a method for generating order data for execution of the plurality of tasks 212 based on dependency data, in accordance with an embodiment of the disclosure. FIG. 4B is explained in conjunction with elements from FIG. 1, FIG. 2, FIG. 3, and FIG. 4A.

At 408, a determination is made to check if the first task 212A of the plurality of tasks 212 is dependent on the second task 212B of the plurality of tasks 212 based on the determined dependency data. In an example, the system 202 is configured to determine whether the first task 212A is dependent on the second task 212B based on the determined dependency data. In an exemplary embodiment, if the dependency data determined by the system 202 indicates that the predicted input data required for execution of the first task 212A corresponds to the predicted output data associated with execution of the second task 212B, then control of the method moves to 410A.

At 410A, one or more second resources from the one or more resources 206A are allocated for execution of the second task. In an example, the system 202 is configured to determine that allocation is to be performed for execution of the second task 212B before execution of the first task 212A. The one or more second resources are required for execution of the second task 212B. In an exemplary embodiment, the system 202 determines the one or more second resources that are required for execution of the second task 212B in the virtual environment 208 (such as the metaverse) using the ML model 202A. The one or more second resources may include, but are not limited to, compute resources, cloud storage, database services, real-time data streaming, one or more load balancing services, and the AI model for data analytics. In an exemplary embodiment, upon the determination of the one or more second resources that need to be allocated to the second task 212B for execution of the second task 212B, in an exemplary embodiment, the system 202 generates a queue and enqueues an operation associated with the allocation of the one or more second resources for execution of the second task 212B into the generated queue. Further, the control of the method moves to 412.

At 412, an operation associated with execution of the second task 212B is enqueued into the generated queue. As described at 408, the system 202 determines that execution of the first task 212A is dependent on execution of the second task 212B, this implies that the second task 212B needs to be executed before the first task 212A. In order to execute the second task 212B, the system 202 enqueues the operation associated with execution of the second task 212B in the generated queue while allocating the second resources from the resources 206A for execution of the second task 212B. Subsequently, the second task 212B may get executed using the second resources. Further, the control of the method moves to 414.

At 414, one or more first resources of the one or more resources 206A are allocated for execution of the first task 212A. In an example, the system 202 is configured to allocate the one or more first resources for the first task 212A.

In an example, the one or more first resources may include common resource(s) that may also be present or be a part of the one or more second resources. In such a case, the allocation of the common resource(s) in a hierarchical manner, i.e., based on dependency of the tasks 212, may ensure that the tasks 212 are performed in a flow and optimally. Optimal and in-flow execution of the tasks 212 ensures that the workflow 210 is efficiently completed, such as I reduced time, with better speed and/or with better output efficiency. As a result, an entity executing the second task 212B may not be interrupted owing to the unavailability of the common resource(s) that may also be used for executing the first task 212A simultaneously.

In an example, the one or more first resources may be mutually exclusive from the one or more second resources. In such a case, the first task 212A and the second task 212B may be executed in parallel.

The one or more first resources may include, but are not limited to, the compute resources, the cloud storage, the database services, the real-time data streaming, the one or more load balancing services, and the AI model for data analytics. Further, the system 202 enqueues an operation corresponding to the allocation of the one or more first resources of the one or more resources 206A for execution of the first task 212A in the generated queue. The control of the method moves to 416.

At 416, an operation associated with execution of the first task 212A is enqueued into the generated queue. In an exemplary embodiment, the system 202 is configured to enqueue the operation associated with execution of the first task 212A. Upon enqueuing the operation associated with execution of the first task 212A, the system 202 may generate and update the exemplary queue. The generated exemplary queue follows a sequential order for execution of each task of the plurality of tasks 212. Further, the control of the method moves to 424.

At 424, the system 202 generates order data for execution of the plurality of tasks 212 based on the dependency data. In an exemplary embodiment, the generated exemplary queue represents the order data as the generated exemplary queue is indicative of the sequential order for execution of each task of the plurality of tasks 212.

In an exemplary embodiment, the generated order data shows that if the first task 212A is dependent on the second task 212B, then the system 202 allocates one or more second resources for execution of the second task 212B at a first timestamp. Further, the system 202 executes the second task at a second timestamp. The system 202 further allocates the one or more first resources for execution of the first task 212A at a third timestamp. Further, the system 202 executes the first task 212A at a fourth timestamp. In an embodiment, the first timestamp occurs before the second timestamp, the second timestamp occurs before the third timestamp, and the third timestamp occurs before the fourth timestamp.

In an embodiment, at 408, the system 202 determines that the first task 212A of the plurality of tasks 212 is independent of the second task 212B of the plurality of tasks 212 based on the determined dependency data. In other words, the dependency data determined by the system 202 indicates that the predicted input data required for execution of the first task 212A (such as the visual design review of the product) does not correspond to the predicted output data associated with execution of the second task 212B (such as the digital twin simulation of the product), then control of the method moves to 410B.

At 410B, the one or more first resources are allocated for execution of the first task 212A. In an exemplary embodiment, the system 202 determines the one or more first resources that are required for execution of the first task 212A in the virtual environment (such as the metaverse) using the ML model 202A. In an exemplary embodiment, upon the determination of the one or more first resources that need to be allocated to the first task 212A for execution of the first task 212A, in an exemplary embodiment, the system 202 generates an exemplary queue and enqueues an operation associated with the allocation of the one or more first resources for execution of the first task 212A into the generated exemplary queue. Further, the control of the method moves to 418.

At 418, an operation associated with execution of the first task 212A is enqueued into the generated exemplary queue. In an example, the system 202 is configured to determine that execution of the first task 212A is independent of execution of the second task 212B, this implies that the first task 212A needs to be executed before the second task 212B is executed or in parallel to the second task. In order to execute the first task 212A, the system 202 enqueues the operation associated with execution of the first task 212A in the generated exemplary queue. Further, the control of the method moves to 420.

At 420, the one or more second resources are allocated for execution of the second task 212B (such as the visual design review of the product). In an example, the system 202 enqueues an operation corresponding to the allocation of the one or more second resources for execution of the second task 212B in the generated exemplary queue. The control of the method moves to 422.

In an embodiment, the system 202 receives the completion status of the first task 212A. Upon reception of the completion status, the system 202 validates the reported completion status to ensure its accuracy and reliability. This validation process involves cross-checking the status against expected outcomes, verifying that the first task 212A has been fully and correctly completed without errors or discrepancies.

Further, upon the successful validation, the system 202 controls the allocation of one or more second resources based on the verified completion status. By dynamically allocating these resources, the system 202 ensures that the second task in the virtual environment is executed efficiently and without delay. This automated process facilitates smooth workflow transitions and optimizes utilization of the one or more resources 206A, thereby enhancing the overall performance and reliability of execution of the plurality of tasks 212 within the virtual environment 208.

At 422, an operation associated with execution of the second task 212B is enqueued into the generated exemplary queue. In an exemplary embodiment, upon enqueuing the operation associated with execution of the second task 212B, the system 202 generates and updates the exemplary queue. Further, the control of the method moves to 424.

At 424, the order data for execution of the plurality of tasks 212 is generated based on the dependency data. In an exemplary embodiment, the generated exemplary queue represents the order data as the generated exemplary queue is indicative of the sequential order for execution of each task of the plurality of tasks 212.

In an exemplary embodiment, the generated order data shows that if the first task 212A is independent of the second task 212B, then the system 202 allocates one or more first resources to the first task 212A at the first timestamp. Further, the system 202 executes the first task at the second timestamp. The system 202 further allocates the one or more second resources to the second task 212B at the third timestamp. Further, the system 202 executes the second task 212B at the fourth timestamp. In an embodiment, the first timestamp occurs before the second timestamp, the second timestamp occurs before the third timestamp and the fourth time period occurs after the third timestamp.

In an alternate embodiment, the system 202 allocates the one or more first resources to the first task 212A and the one or more second resources to the second task 212B parallelly based on the determination that execution of the first task 212A is independent of execution of the second task 212B. In this scenario, the system 202 allocates the one or more first resources to the first task 212A and the one or more second resources to the second task 212B within a first time period. Further, the system executes the first task 212A, and the second task 212B parallelly. In this scenario, the system executes the first task 212A, and the second task 212B within a second time period.

In an exemplary embodiment, the system 202 performs real-time simulations that determine what may be the most optimal way to execute the workflow 210. The system 202 determines if there exists a way that execution of the workflow 210 could be optimized by changing the order of execution of the plurality of tasks 212. The system 202 integrates workflow simulation, process mining, and machine learning to enhance process efficiency and reliability. By employing the ML model 202A, the system 202 models various workflow scenarios, identifying potential bottlenecks and performance issues such as delays or service outages. The process mining component extracts and analyzes event logs to visualize and diagnose inefficiencies, while real-time performance monitoring tracks the health and availability of the one or more resources 206A such as cloud resources. Leveraging these insights, the system 202 applies the ML model 202A to predict and recommend the most effective execution paths. Further, continuous feedback mechanisms from the user 216 and predictive analytics ensure that the workflow 210 is dynamically refined, addressing root causes and adapting to new data to ensure optimal execution of the workflow 210.

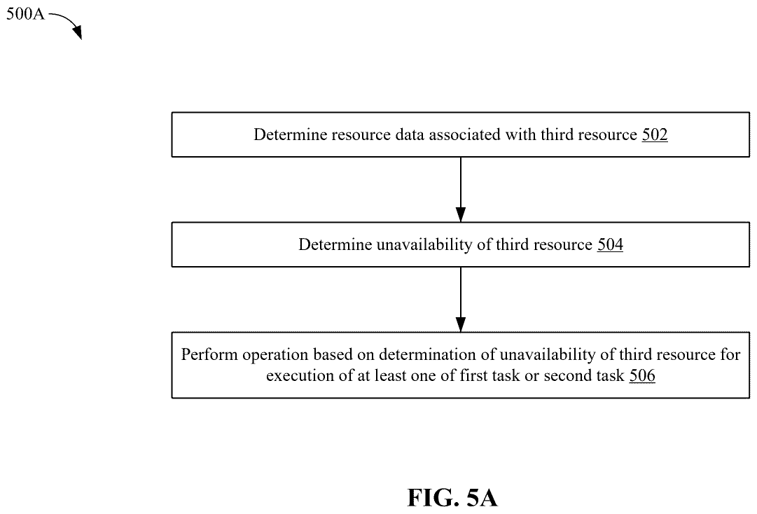

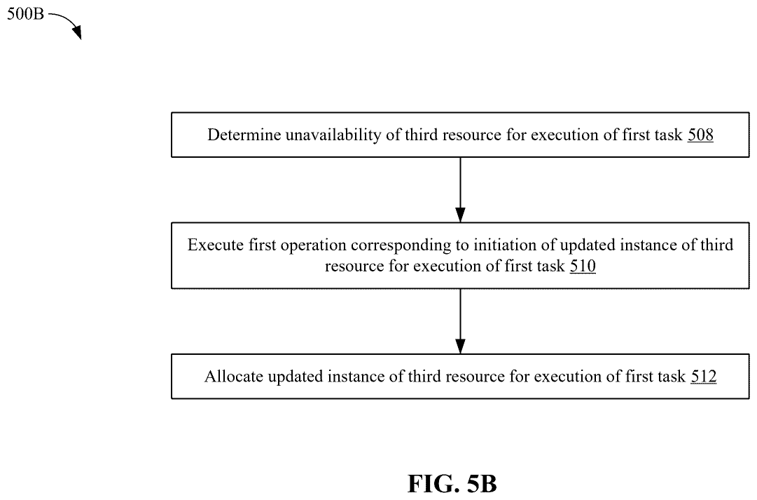

FIG. 5A illustrates a flowchart 500A of a method for performing an operation for execution of first task or second task, in accordance with an embodiment of the disclosure. FIG. 5A is explained in conjunction with elements of FIG. 1, FIG. 2, FIG. 3, FIG. 4A, and FIG. 4B.

In an embodiment, the system 202 determines the dependency data associated with the plurality of tasks 212, the dependency data is indicative of a dependency relationship, for example, between the first task 212A and the second task 212B. In an exemplary embodiment, the system 202 determines that execution of the second task 212B is dependent on execution of the first task 212A as input data associated with the second task 212B corresponds to output data generated on execution of the first task 212A. In order to execute the first task 212A, the system 202 determines the first execution data indicative of the one or more first resources required for execution of the first task 212A. In an exemplary embodiment, the one or more first resources required for execution of the first task 212A include a first resource, a second resource, and a third resource.

Moreover, the system 202 further determines the second execution data associated with the second task. The second execution data is indicative of the one or more second resources required for execution of the second task 212B. In an exemplary embodiment, to execute the second task 212B, the system 202 determines the second execution data indicative of the one or more second resources required for execution of the second task 212B. In an exemplary embodiment, the one or more second resources may also include a third resource, a fourth resource, and a fifth resource.

In an example, resource data associated with each of the one or more first resources and the one or more second resources are determined. In an example, the system 202 is configured to determine the resource data associated with each of the one or more first resources and the one or more second resources. In an embodiment, the resource data indicates one or more attributes associated with each of the one or more first resources and each of the one or more second resources. The one or more attributes include, for example, but are not limited to, the type of a resource, compatibility of the resource, provider of the resource, accessibility of the resource, and availability and/or amount of the resource.

The system 202 further controls the allocation of the one or more first resources for execution of the first task 212A and the one or more second resources for execution of the second task 212B in the virtual environment 208 based on the dependency relationship. For example, if the dependency relationship indicates that the first task 212A is dependent on the second task 212B, then the system 202 controls the allocation of the one or more second resources for execution of the second task 212B before the allocation of the one or more first resources for execution of the first task 212A, and vice-versa.

The system 202 is integrated with the computing environment 206 that includes the one or more resources 206A, such as cloud resources to monitor and manage resource utilization, including CPU usage, memory allocation, and storage capacity. As workflow 210 gets executed within the virtual environment 208, such as the Metaverse, the system 202 continuously analyzes the performance of underlying cloud services. It collects data on peak CPU loads, maximum storage thresholds, and potential issues with cloud security or authentication services. For instance, if the system 202 detects that a cloud security service is nearing peak storage or encountering performance issues due to high user demand or a memory leak, the system 202 dynamically responds by leveraging integration feeds from the one or more resource providers such as cloud service providers. The system 202 can trigger actions such as provisioning additional cloud resources to balance the load, scaling up compute capacity to handle increased user activity or deploying additional storage solutions. It also performs root cause analysis to distinguish between temporary issues and persistent faults, such as a memory leak, ensuring that solutions address the underlying problems rather than merely providing short-term fixes. By dynamically configuring cloud services and performing comprehensive analysis, the system 202 maintains efficient and reliable operation of workflows within the virtual environment 208, ensuring continuous user access and performance stability

At 502, the resource data associated with the third resource is determined. In an example, the system 202 is configured to determine the resource data associated with the third resource. The resource data is indicative of one or more attributes associated with the third resource. In an exemplary embodiment, the third resource may correspond to, for example, but not limited to, cloud storage. In such a case, the system 202 determines the resource data associated with the cloud storage. The system 202 determines one or more attributes associated with the cloud storage for execution of the first task. For example, the system 202 determines the type of the cloud storage, the capacity of the cloud storage, the security parameter of the cloud storage, or the amount of cloud storage required for execution of the first task 212A.

For example, the third resource may be common amongst the one or more first resources and the one or more second resources. As a result, the third resource may be required and/or utilized for execution of the first task 212A as well as the second task 212B. Further, the system 202 is configured to control the allocation of the third resource to the first task 212A and the second task 212B based on the determination of the resource data.

At 504, the third resource is determined to be unavailable. For example, the system 202 determines the unavailability of the third resource based on the one or more attributes. In an exemplary embodiment, the system 202 determines that the third resource of the one or more first resource required for execution of the first task 212A is unavailable due to, for example, lack of enough capacity of the third resource than a capacity required for execution of the third resource. Alternatively, the third resource may be unavailable for execution of the second task 212B, for example, when the first task utilizes the available capacity of the third resource. Further, the determination of the unavailability of the third resource is made by utilizing the resource data associated with the third resource. The unavailability of the third resource may correspond to a failure in execution of the first task 212A and/or the second task 212B.

At 506, an operation is performed for execution of the first task and/or the second task on the third resource. In an example, the system 202 is configured to perform an operation (referred to as a remedy operation, hereinafter) based on the determination of the unavailability of the third resource. In an exemplary embodiment, the remedy operation may include, for example, but not limited to, a first operation corresponding to scaling the third resource, or a second operation corresponding to triggering a notification for the third resource.

FIG. 5B illustrates a flow diagram 500B that depicts an exemplary scenario of performing a first operation, in accordance with an embodiment of the disclosure. In an example, the first operation (referred to as the first remedy operation) may be performed to initiate an updated instance of the unavailable third resource and allocate the updated instance of the third resource for execution of the first task 212A. While the present example is described as utilizing the unavailable third resource for executing the first task 212A, this should not be construed as a limitation. In an example, the third resource may have to be utilized for executing the second task 212B and/or any other task from the tasks 212. Moreover, such tasks may have to be executed in a parallel, sequential, or partially sequential manner. FIG. 5B is explained in conjunction with elements of FIG. 1, FIG. 2, FIG. 3, FIG. 4A, FIG. 4B, and FIG. 5A.

At 508, the unavailability of the third resource required for execution of the first task 212A is determined. In an example, the system 202 is configured to determine the unavailability of the third resource required for execution of the first task 212A. The third resource corresponds to a memory required for execution of the first task 212A. Further, if the system 202 determines that the memory required for execution of the first task 212A is unavailable. For example, the unavailability of the third resource may be determined based on the current capacity of the memory is less than the required capacity of the memory for executing the first task 212A, expired or offline status of the memory, or utilization of the memory is additional operation. In such a case, the system 202 executes a first remedy operation at 510.

At 510, the first operation is executed. For example, the system 202 executes the first operation or the first remedy operation corresponding to the initiation of an updated instance of the required third resource for execution of the first task 212A. In an exemplary embodiment, if the memory required for execution of the first task 212A is unavailable, the system 202 performs scaling of the third resource, i.e., the memory, or triggering a notification for the third resource.

In one exemplary scenario, if the memory required for execution of the first task 212A is unavailable, i.e., less than the required amount for execution of the first task 212A, then the system 202 executes the first remedy operation that corresponds to scaling of the third resource. The system 202 initiates an updated instance of the required memory for execution of the first task 212A. The updated instance includes the amount of memory that is needed for execution of the first task 212A and/or other tasks of the tasks 212 that may also utilize the third resource, i.e., the memory. The instantiation of the updated instance may lead to the creation of a new instance of the memory. The updated instance is a specific realization of the memory.

At 512, the updated instance of the third resource is allocated for execution of the first task 212A. For example, the system 202 is configured to allocate the updated instance of the third resource for execution of the first task 212A. Similarly, the system 202 executes methods for determining the unavailability of each resource of the one or more resources for execution of each task of the plurality of tasks 212.

In an exemplary scenario, if the system 202 determines an error in the allocation of the third resource required for execution of the first task 212A, the system 202 performs the first remedy operation corresponding to triggering the notification for the third resource. The system 202 notifies an administrator, a user, and/or a service provider of the third resource to rectify an error in the allocation of the third resource required for execution of the first task 212A.

In an exemplary embodiment, the system 202 utilizes the trained ML model 202A to analyze historical execution of the first task 212A and determine if a failure in the allocation of the third resource occurred in historical execution of the first task 212A. Further, the system 202 determines the first remedy operation executed to rectify the failure in the allocation of the third resource that occurred in historical execution of the first task 212A. The system 202 further performs the determined first remedy operation to rectify the failure in the allocation of the third resource that occurred in historical execution of the first task 212A on the current day of operation.

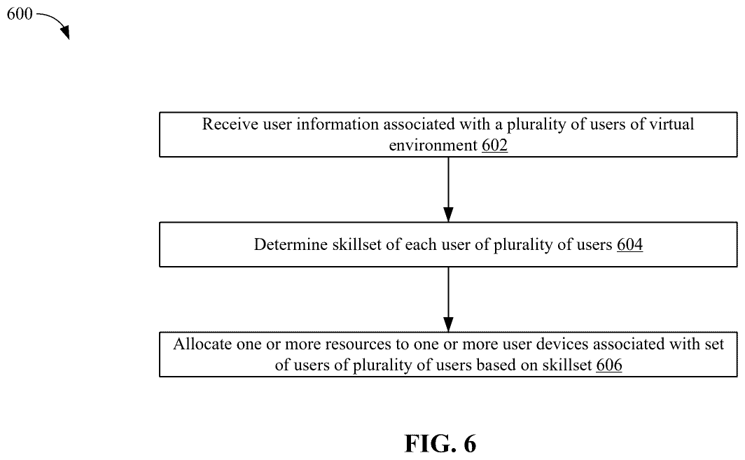

FIG. 6 illustrates a flowchart 600 of a method for allocating one or more resources to one or more user devices for executing tasks 212, in accordance with an embodiment of the disclosure. FIG. 6 is explained in conjunction with elements of FIG. 1, FIG. 2, FIG. 3, FIG. 4A, FIG. 4B, FIG. 5A, and FIG. 5B.

At 602, user information is received. For example, the system 202 receives the user information associated with a plurality of users of the virtual environment 208 from one or more sources. The user information includes, for example, but is not limited to, skills data of each user of the plurality of users and user device data of each user of the plurality of users.

In an exemplary embodiment, the system 202 receives the user information via an opt-in model. The opt-in model is utilized for collecting skillsets including obtaining explicit consent from a plurality of users before gathering and using data related to their skills, expertise, or professional qualification. In an embodiment, the skillset includes, for example, but is not limited to, skills in one or more programming languages, machine learning expertise, and cloud platform knowledge.

At 604, the skillset of each user of the plurality of users is determined. In an example, the system 202 is configured to determine the skillset of each user of the plurality of users. In an exemplary embodiment, the system 202 determines the skill set required to execute each task of the plurality of tasks. Further, the system 202 determines the skillset of each user of the plurality of users from the received user information from one or more sources.

In an exemplary scenario, the system 202 determines the skillset associated with a first user of the plurality of users by utilizing the user information associated with the first user. The user information associated with the first user indicates that the first user has one of, for example, machine learning expertise, quality analysis (QA) expertise, development expertise, etc. Similarly, the system 202 determines the skillset of each user of the plurality of users based on the received user information associated with each user of the plurality of users.

At 606, the one or more resources 206A are allocated to one or more user devices associated with a set of users of the plurality of users based on the skillset. For example, the system 202 allocates the one or more resources 206A to the one or more user devices associated with a set of users of the plurality of users based on the corresponding user information. The one or more resources 206A are allocated to the one or more user devices in the virtual environment 208 for execution of a task of the plurality of tasks 212.

In an exemplary embodiment, the system 202 determines the user device data of the one or more user devices associated with the set of users of the plurality of users. In an embodiment, the set of users may include a first set of users, a second set of users, a third set of users, and up to a Nth set of users. In a scenario, the first set of users have the same or similar skillset. For example, the determined skillset of the first set of users corresponds to the development expertise. Further, the system 202 determines that execution of the first task 212A requires the development expertise. In this case, the system 202 allocates the one or more resources (such as compute processing, memory, database, etc.) that are required to perform the first task 212A to one or more user devices associated with the first set of users. In this manner, different users are engaged as participants of the virtual environment 208 for executing the tasks 212 and the workflow 210.

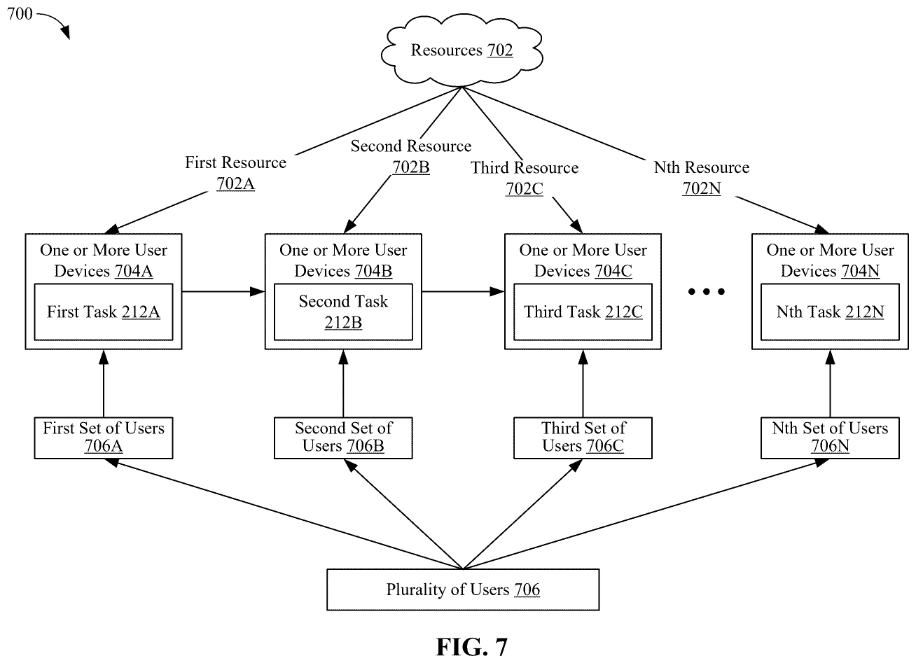

FIG. 7 illustrates a block diagram 700 for executing each task of the plurality of tasks 212 based on allocation of resources 702 to one or more user devices, in accordance with an embodiment of the disclosure. FIG. 7 is explained in conjunction with examples of FIG. 1, FIG. 2, FIG. 3, FIG. 4A, FIG. 4B, FIG. 5A, FIG. 5B, and FIG. 6.

In an embodiment, as shown in FIG. 7 the system 202 allocates the one or more resources 702 to one or more user devices to execute the plurality of tasks 212 based on the received user information associated with a plurality of users 706 in the virtual environment 208 and user device data associated with the one or more user devices (depicted as user devices 704A, 704B, 704C, up to 704N, and collectively referred to as user devices 704).

In a scenario, the system 202 determines using the ML model 202A that execution of the first task 212A requires the machine learning expertise, execution of the second task 212B requires the skillset with one or more programming languages, execution of the third task 212C requires the cloud platform knowledge. In an embodiment, the system 202 further determines the skillset of each of the plurality of users 706 using the user information received from the one or more sources.

For example, the system 202 determines that a first set of users 706A of the set of users associated with the plurality of users 706 have the machine learning expertise, a second set of users 706B of the plurality of users 706 have one or more programming languages expertise, a third set of users 706C of the plurality of users 706 have the cloud platform knowledge. In this scenario, the system 202 identifies the first set of users 706A for execution of the first task 212A. Further, the system 202 allocates the first resource 702A from the resource 702 to the one or more user devices 704A associated with the first set of users 706A.

Further, the system 202 identifies the second set of users 706B for execution of the second task 212B. Further, the system 202 allocates the second resource 702B from the resource 702 to the one or more user devices 704B associated with the second set of users 706B. The system 202 further identifies the third set of users 706C for execution of the third task 212C and allocates the third resource 702C from the resource 702 to the one or more user devices 704C associated with the third set of users 706C.

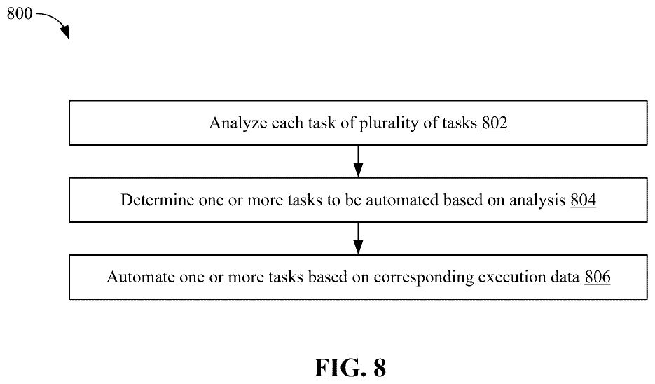

FIG. 8 illustrates a flowchart 800 of a method for automating one or more tasks of the plurality of tasks 212, in accordance with an embodiment of the disclosure. FIG. 8 is explained in conjunction with examples of FIG. 1, FIG. 2, FIG. 3, FIG. 4A, FIG. 4B, FIG. 5A, FIG. 5B, FIG. 6, and FIG. 7.

At 802, each task of the plurality of tasks 212 is analyzed. In an example, the system 202 is configured to analyze each task of the plurality of tasks 212 using the trained ML model 202A. In an exemplary embodiment, the analysis is done based on the training workflow data 302. The system 202 analyses historical execution of each task of the plurality of tasks 212 associated with the workflow 210.

At 804, one or more tasks to be automated are determined. In an example, the system 202 is configured to determine the one or more tasks from the tasks 212 to be automated based on the analysis. Once the tasks are analyzed, the system 202 uses the ML model 202A to determine which tasks are best suited for automation. In a scenario, the ML model 202A identifies tasks, such as generating virtual environment reports, synchronizing user activity logs, and updating virtual object states, as such tasks may be repetitive and resource-intensive. The ML model 202A recommends automating these tasks to enhance efficiency for execution of the workflow 210. For instance, automating the synchronization of user activity logs may ensure that data is consistently updated across all virtual platforms without manual intervention, leading to improved data accuracy and operational efficiency.

At 806, the one or more tasks are automated. In an example, the system 202 is configured to determine the one or more tasks of the plurality of tasks 212 that may be suitable for automation through the analysis provided by the ML model 202A. Thereafter, the system 202 proceeds to automate these tasks based on the corresponding execution data to minimize human intervention and enhance the efficiency of execution of the workflow 210. For example, if the ML model 202A flags one or more tasks such as, but not limited to, generating virtual environment reports, synchronizing user activity logs, and updating virtual object states as repetitive and resource intensive. In an example, the system 202 initiates automation protocols for the identified one or more tasks to be automated. Such automation of the one or more tasks streamlines workflow execution and reduces the potential for human error, allowing the system 202 to handle routine tasks more efficiently and reliably. Consequently, the overall operational efficiency is improved, as automated processes may perform tasks (or sub-tasks) faster and with greater precision than manual methods, freeing up human resources for more strategic activities.

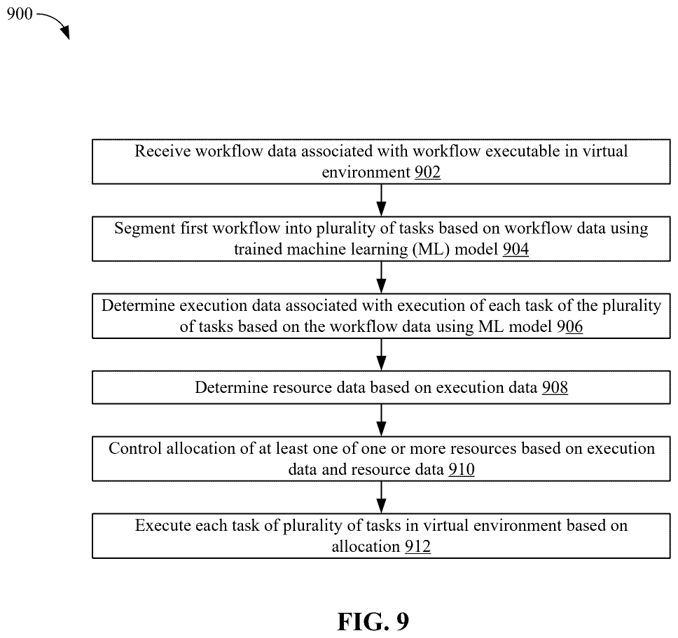

FIG. 9 illustrates a flowchart 900 of an exemplary method for dynamically allocating the one or more resources 206A for workflow execution in the virtual environment 208, in accordance with an embodiment of the disclosure. FIG. 9 is explained in conjunction with elements of FIG. 1, FIG. 2, FIG. 3, FIG. 4A, FIG. 4B, FIG. 5A, FIG. 5B, FIG. 6, FIG. 7, and FIG. 8. With reference to FIG. 9, there is shown a flowchart 900. The operations of the exemplary method may be executed by any computing system, for example, by the computer 102 of FIG. 1 or the system 202 of FIG. 2. The operations of the flowchart 900 may start at 902.

At 902, the workflow data 302 associated with the workflow 210 executable in the virtual environment 208 is received. In an embodiment, the system 202 receives the workflow data 302 corresponding to the workflow 210 executable in the virtual environment 208.

At 904, the workflow 210 is segmented into the plurality of tasks 212 based on the workflow data 302, using the trained machine learning model 202A. The ML model 202A is trained based on the training workflow data 302 associated with execution of the plurality of training workflows. In an embodiment, the system 202 segments the workflow 210 into the plurality of tasks 212 based on the workflow data 302 using the trained ML model 202A. The ML model 202A is trained based on the training workflow data 302 associated with execution of the plurality of training workflows.

At 906, the execution data associated with execution of each task of the plurality of tasks 212 is determined based on the workflow data 302 using the ML model 202A. In an embodiment, the system 202 determines the execution data associated with execution of each task of the plurality of tasks 212 based on the workflow data 302 using the ML model 202A.

At 908, the resource data is determined based on the execution data. The resource data is associated with each of the one or more resources 206A associated with execution of each task of the plurality of tasks 212. In an embodiment, the system 202 determines the resource data based on the execution data. The resource data is associated with each of the one or more resources 206A associated with execution of each task of the plurality of tasks 212.

At 910, the allocation of at least the one or more resources 206A is controlled based on the execution data and the resource data. The at least one of the one or more resources 206A is allocated for execution of each task of the plurality of tasks 212 in the virtual environment 208. In an embodiment, the system 202 controls the allocation of at least the one or more resources 206A based on the execution data and the resource data. The at least one of the one or more resources 206A is allocated for execution of each task of the plurality of tasks 212 in the virtual environment 208.

At 912, each task of the plurality of tasks 212 is executed in the virtual environment 208 based on the allocation. In an embodiment, the system 202 executes each task of the plurality of tasks 212 in the virtual environment 208 based on the allocation.

Various embodiments of the disclosure may provide a non-transitory computer readable medium and/or storage medium having stored thereon, instructions executable by a machine and/or a computer to operate a system (e.g., the system 202) for dynamic allocation of resources, such as cloud resources in virtual environments. The instructions may cause the machine and/or computer to receive workflow data associated with a workflow executable in a virtual environment. The program instructions further cause the system to segment using a trained machine learning (ML) model, the workflow into a plurality of tasks based on the workflow data, the ML model is trained based on training workflow data associated with execution of a plurality of training workflows. The program instructions further cause the system to determine using the trained ML model, execution data associated with the execution of each task of the plurality of tasks based on the workflow data. The execution data indicates one or more resources for execution of each task of the plurality of tasks. The program instructions further cause the system to determine resource data based on the execution data. The resource data is associated with each of the one or more resources associated with execution of each task of the plurality of tasks. The program instructions further cause the system to control an allocation of at least one of the one or more resources based on the execution data and the resource data. The at least one of the one or more resources is allocated for execution of each task of the plurality of tasks in the virtual environment. The program instructions further cause the system to execute each task of the plurality of tasks in the virtual environment based on the allocation.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, workflow data associated with a workflow executable in a virtual environment;
segmenting, by the computer using a trained machine learning (ML) model, the workflow into a plurality of tasks based on the workflow data, the ML model is trained based on training workflow data associated with execution of a plurality of training workflows;
determining, by the computer using the trained ML model, execution data associated with execution of each task of the plurality of tasks based on the workflow data, wherein the execution data indicates one or more resources for execution of each task of the plurality of tasks;
determining, by the computer, resource data based on the execution data, wherein the resource data is associated with each of the one or more resources associated with execution of each task of the plurality of tasks;
controlling, by the computer, an allocation of at least one of the one or more resources based on the execution data and the resource data, wherein the at least one of the one or more resources is allocated for execution of each task of the plurality of tasks in the virtual environment; and
executing, by the computer, each task of the plurality of tasks in the virtual environment based on the allocation.

2. The computer-implemented method of claim 1, wherein the execution data comprises at least one of dependency data associated with each task of the plurality of tasks, complexity data for execution of each task of the plurality of tasks, technical requirement data for execution of each task of the plurality of tasks, or security requirement data for execution of each task of the plurality of tasks.

3. The computer-implemented method of claim 2, further comprising:
predicting, by the computer using the ML model, input data for execution of each task of the plurality of tasks;
predicting, by the computer using the ML model, output data for execution of each task of the plurality of tasks;
determining, by the computer using the ML model, the dependency data associated with each task of the plurality of tasks based on the input data and the output data; and
generating, by the computer, order data based on the dependency data, wherein the order data is generated for execution of the plurality of tasks based on the dependency data.

4. The computer-implemented method of claim 1, further comprising:
receiving, by the computer, user information associated with each user of a plurality of users of the virtual environment, wherein the user information comprises skills data of each user of the plurality of users and user device data of each user of the plurality of users; and
allocating, by the computer, the one or more resources to one or more user devices associated with a set of users of the plurality of users based on the user information associated with each user of the set of users, wherein the one or more resources are allocated to the one or more user devices in the virtual environment for execution of a task of the plurality of tasks.

5. The computer-implemented method of claim 1, further comprising:
determining, by the computer, service data associated with a plurality of service resources executable in the virtual environment, wherein the plurality of service resources comprises the one or more resources associated with execution of each task of the plurality of tasks; and
segmenting, by the computer using the trained ML model, the workflow into the plurality of tasks based on the service data.

6. The computer-implemented method of claim 2, wherein the plurality of tasks comprises a first task and a second task, such that the dependency data indicates a dependency relationship between the first task and the second task, and wherein the method further comprises:
determining, by the computer, first execution data associated with the first task, wherein the first execution data indicates one or more first resources of the one or more resources for execution of the first task, and wherein the execution data comprises the first execution data;
determining, by the computer, second execution data associated with the second task, wherein the second execution data indicates one or more second resources of the one or more resources for execution of the second task, and wherein the execution data comprises the second execution data;
determining, by the computer, resource data associated with each of the one or more first resources and the one or more second resources; and
controlling, by the computer, an allocation of at least one of the one or more first resources or the one or more second resources based on the dependency relationship, wherein the one or more first resources are allocated for execution of the first task and the one or more second resources are allocated for execution of the second task.

7. The computer-implemented method of claim 6, wherein the dependency relationship indicates a dependency of the first task on the second task, and wherein the method further comprises:
controlling, by the computer, the allocation of the one or more first resources for execution of the first task in the virtual environment;
receiving, by the computer from at least one of the one or more first resources, a completion status of the first task;
validating, by the computer, the completion status of the first task; and
controlling, by the computer, the allocation of the one or more second resources based on the validation, wherein the one or more second resources are allocated for execution of the second task in the virtual environment.

8. The computer-implemented method of claim 6, wherein each of the one or more first resources for execution of the first task and the one or more second resources for execution of the second task comprises a third resource, and wherein the method further comprises:
determining, by the computer, resource data associated with the third resource, wherein the resource data indicates one or more attributes of the third resource; and
executing, by the computer, at least one of the first task or the second task using the third resource based on the one or more attributes.

9. The computer-implemented method of claim 8, further comprising:
determining, by the computer, an unavailability of the third resource based on the one or more attributes, wherein the unavailability of the third resource corresponds to a failure in execution of at least one of the first task or the second task; and
performing, by the computer, at least one of scaling the third resource or triggering a notification for the third resource based on the determination of the unavailability of the third resource.

10. The computer-implemented method of claim 9, further comprising:
determining, by the computer, the unavailability of the third resource based on the one or more attributes for execution of at least one of the first task or the second task;
initiating, by the computer, an updated instance of the third resource based on the determination, wherein the updated instance is initiated for execution of at least one of the first task or the second task; and
allocating, by the computer, the updated instance of the third resource for execution of at least one of the first task or the second task.

11. The computer-implemented method of claim 1, further comprising:
analyzing, by the computer using the ML model, each task of the plurality of tasks based on the workflow data;
determining, by the computer using the ML model, one or more tasks of the plurality of tasks based on the analysis, wherein the one or more tasks are to be automated; and
automating, by the computer, the one or more tasks of the plurality of tasks based on the corresponding execution data.

12. The computer-implemented method of claim 1, wherein the one or more resources associated with execution of each task of the plurality of tasks are cloud resources.

13. The computer-implemented method of claim 1, wherein the virtual environment corresponds to a metaverse environment.

14. The computer-implemented method of claim 1, wherein the one or more resources comprise at least a digital twin, an Artificial Intelligence (AI) model, one or more security resources, one or more analytics resources, and one or more load balancing resources.

15. A computer system, comprising:
a processor set;
one or more computer-readable storage media; and
program instructions stored on the one or more computer-readable storage media, the program instructions executable by the processor set to cause the processor set to:
receive workflow data associated with a workflow executable in a virtual environment;
segment, using a trained machine learning (ML) model, the workflow into a plurality of tasks based on the workflow data, the ML model is trained based on training workflow data associated with execution of a plurality of training workflows;
determine, using the trained ML model, execution data associated with execution of each task of the plurality of tasks based on the workflow data, wherein the execution data indicates at least one of dependency data associated with each task of the plurality of tasks or one or more resources for execution of each task of the plurality of tasks;
determine resource data based on the execution data, wherein the resource data is associated with each of the one or more resources associated with execution of each task of the plurality of tasks;
control an allocation of at least one of the one or more resources based on the dependency data and the resource data, wherein the at least one of the one or more resources is allocated for execution of each task of the plurality of tasks in the virtual environment; and
execute each task of the plurality of tasks in the virtual environment based on the allocation.

16. The computer system of claim 15, wherein the execution data comprises at least one of complexity data for execution of each task of the plurality of tasks, technical requirement data for execution of each task of the plurality of tasks, or security requirement data for execution of each task of the plurality of tasks.

17. The computer system of claim 16, wherein the program instructions further cause the processor set to:
predict, using the ML model, input data for execution of each task of the plurality of tasks;
predict, using the ML model, output data for execution of each task of the plurality of tasks;
determine, using the ML model, the dependency data associated with each task of the plurality of tasks based on the input data and the output data; and
generate order data based on the dependency data, wherein the order data is generated for execution of the plurality of tasks.

18. The computer system of claim 15, wherein the program instructions further cause the processor set to:
receive, user information associated with each of a plurality of users of the virtual environment, wherein the user information comprises skills data of each user of the plurality of users and user device data of each user of the plurality of users; and
allocate the one or more resources to one or more user devices associated with a set of users of the plurality of users based on the corresponding user information, wherein the one or more resources are allocated to the one or more user devices in the virtual environment for execution of a task of the plurality of tasks.

19. The computer system of claim 15, wherein the program instructions further cause the processor set to:
determine service data associated with a plurality of service resources executable in the virtual environment, wherein the plurality of service resources comprises the one or more resources associated with execution of each task of the plurality of tasks; and
segment using the trained ML model, the workflow into the plurality of tasks based on the service data.

20. A computer program product comprising a computer-readable storage medium having program instructions embodied therewith, the program instructions executable by a system to cause the system to:
receive workflow data associated with a workflow executable in a virtual environment;
segment, using a trained machine learning (ML) model, the workflow into a plurality of tasks based on the workflow data, the ML model being is based on training workflow data associated with execution of a plurality of training workflows;
determine, using the trained ML model, execution data associated with execution of each task of the plurality of tasks based on the workflow data, wherein the execution data indicates one or more resources for execution of each task of the plurality of tasks;
determine resource data based on the execution data, wherein the resource data is associated with each of the one or more resources associated with execution of each task of the plurality of tasks;
control an allocation of at least one of the one or more resources based on the execution data and the resource data, wherein the at least one of the one or more resources is allocated for execution of each task of the plurality of tasks in the virtual environment; and
execute each task of the plurality of tasks in the virtual environment based on the allocation.
